(19) United States
(12) Patent Application Publication
(10) Pub. No.: US 2008/0115517 A1
(43) Pub. Date: May 22, 2008

(54) Vehicle Door Closing Energy Reduction Through HVAC Mode Door Control

(75) Inventors: Adam Tacey, Farmington Hills, MI (US); David Lyon, Farmington Hills, MI (US); Laura Bentley, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/561,655

(22) Filed: Nov. 20, 2006

(51) Int. Cl. B60H 1/00

(52) U.S. Cl. 62/244

(57) ABSTRACT

An apparatus and method for providing a partial recirculation mode of operation in an HVAC control system of a vehicle to place a fresh air passage, a recirculation passage, and an interior passage in fluid communication to reduce vehicle door closing energy by allowing external discharge of cabin air pressure from the interior passenger compartment through the fresh air passage during vehicle door closure. The partial recirculation mode bypasses distribution vent covers, distribution ductwork, heater and evaporator cores, and blowers in order to open a more direct air outlet path to atmosphere which can be activated as required in order to reduce vehicle door closing energy. The partial recirculation mode of operation is activated in response to predetermined vehicle conditions, such as, ignition switched off seat belt unbuckled, transmission switched to park, emergency brake applied, vehicle door opened, vehicle door unlocked, and/or vehicle seat sensor switched to unoccupied.

### FIELD OF THE INVENTION

The present invention relates to an HVAC control system for a vehicle including an interior passage extending between an opening into an interior passenger compartment of a vehicle and an air distribution chamber, a fresh air passage extending between an opening external to the passenger compartment of the vehicle and the distribution chamber, a recirculation passage extending between an opening in the interior passenger compartment and the air distribution chamber, and at least one movable intake door located in the distribution chamber for changing modes of HVAC operation between a fresh air mode and a recirculation mode, where the fresh air mode of operation places the fresh air passage in fluid communication with the interior passage, where the recirculation mode of operation places the recirculation passage in fluid communication with the interior passage, and more particularly to a partial recirculation mode of HVAC operation, where the partial recirculation mode of operation places the fresh air passage, the recirculation passage, and the interior passage in fluid communication with one another to reduce vehicle door closing energy by allowing external discharge of air from the interior passenger compartment through the fresh air passage during vehicle door closure.

### BACKGROUND

The amount of energy required to close a vehicle door is driven by three main components: (1) seal and latch force; (2) hinge and check link friction; and (3) cabin air pressure. Currently vehicles rely primarily on a drafter, sometimes referred to as a pressure relief valve or pressure exhaust valve, at the rear of the vehicle and by general body leakage to vent increased pressure in the cabin due to a closing door. Body leakage is continually being reduced in vehicles in order to improve noise, vibration, harshness (NVH) and heating ventilating and air conditioning (HVAC). The rate at which cabin air travels through the drafter is driven by the size of the drafter and by the restriction in the path from the main cabin volume to the drafter surface. Drafter size is minimized and the restrictions in flow are increased to improve NVH. These factors have increased the air-tight effect in door closing energy.

### SUMMARY

The present invention provides a method to reduce the effect of cabin air pressure on door energy closing. The invention provides a method to increase the venting capacity of a vehicle without degrading NVH or HVAC performance. The method relies on the control of the HVAC intake door. In a typical HVAC system, there are two positions of the mode door: fresh air and recirculation modes. In the fresh air mode, the intake door is open such that the flow path (out of the vehicle) is through the vents, ductwork, heater and evaporator cores, blower, cowl box, and finally, the leaf screen. Inlet air flow is restricted by these devices. In recirculation mode, the mode door is closed so cabin air cannot vent through the HVAC system. The present invention can place the HVAC mode door in a partial recirculation position, which opens a more direct air outlet path to atmosphere external of the vehicle. The air flow bypasses the vents, ductwork, and HVAC unit. This configuration can increase the effect of body leakage without a detriment to NVH as it can be activated as required. The timing of the operation of the mode door can be controlled according to an embodiment of the invention. In order to maximize the effectiveness of the operation on door closing effort, an embodiment of the present invention positions the mode door in a partial recirculation mode when any door is opened. The control can be accomplished with a control system responsive to a vehicle condition input signal or capable of monitoring a vehicle condition. An embodiment of the present invention can position the intake door in a partial recirculation mode when the ignition key is turned off. The system can revert to either a previous mode position, or to a fresh air mode position depending on system conditions after a predetermined period of time. The system can change to partial recirculation mode in response to predetermined vehicle conditions. The vehicle conditions, by way of example and not limitation, can include a signal corresponding to any vehicle door being opened, vehicle ignition being turned off, vehicle transmission being placed in park, emergency brake being engaged, any seat belt condition being changed from buckled to unbuckled, any vehicle door lock being changed from locked to unlocked, any seat occupant sensor change from occupied to unoccupied, and any combination thereof. These vehicle condition input signals can be monitored in a network style smart system configuration, or can be hardwired to receive the vehicle condition input signal, sometimes referred to as a dumb system configuration. Either system configurations, “smart” or “dumb”, can change the mode door to the partial recirculation position based on any of the predetermined vehicle conditions.

An HVAC control system for a vehicle can include an interior passage extending between an opening into an interior passenger compartment of a vehicle and an air distribution chamber. A fresh air passage can extend between an opening external to the passenger compartment of the vehicle and the air distribution chamber. A recirculation passage can extend between an opening in the interior passenger compartment and the air distribution chamber. At least one movable intake door can be located in the distribution chamber for changing modes of HVCA operations between a fresh air mode and a recirculation mode. The fresh air mode of operation can place the fresh air passage in fluid communication with the interior passage. The recirculation mode of operation can place the recirculation passage in fluid communication with the interior passage. An embodiment according to the present invention can include a partial recirculation mode of HVAC operation. The partial recirculation mode of operation can place the fresh air passage, the recirculation passage, and the interior passage in fluid communication with one another to reduce vehicle door closing energy by allowing external discharge of air from the interior passenger compartment through the fresh air passage during vehicle door closure.

A method for reducing the vehicle door closing energy can include defining an additional mode of operation in an HVAC control system corresponding to a partial recirculation mode. The partial recirculation mode of operation can place the fresh air passage, the recirculation passage, and the interior passage in fluid communication with one another to reduce vehicle door closing energy by allowing external discharge of air from the interior passenger compartment through the fresh air passage during vehicle door closure, wherein the partial recirculation mode of operation is activated in response to predetermined conditions. The partial recirculation mode of operation is activated by moving at least one intake door located in a distribution chamber. The door can be moved to different positions for different modes of HVAC operation. A fresh air mode of operation can place the fresh air passage in fluid communication with the interior passage. A recirculation mode of operation can place the recirculation passage in fluid communication with the interior passage. The HVAC system can change modes of operation between the fresh air mode, the recirculation mode, and the partial recirculation mode.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic view of a vehicle having at least two vehicle doors and an HVAC control system for the vehicle;

FIG. 2 is a simplified schematic view of an HVAC control system including an air distribution chamber, a fresh air passage, a recirculation passage, and at least one movable intake door;

FIG. 3 is a simplified control logic flow diagram for the HVAC control system illustrated in FIGS. 1 and 2; and

FIG. 4 is a simplified control logic schematic for activating at least one movable intake door to a partial recirculation mode position.

### DETAILED DESCRIPTION

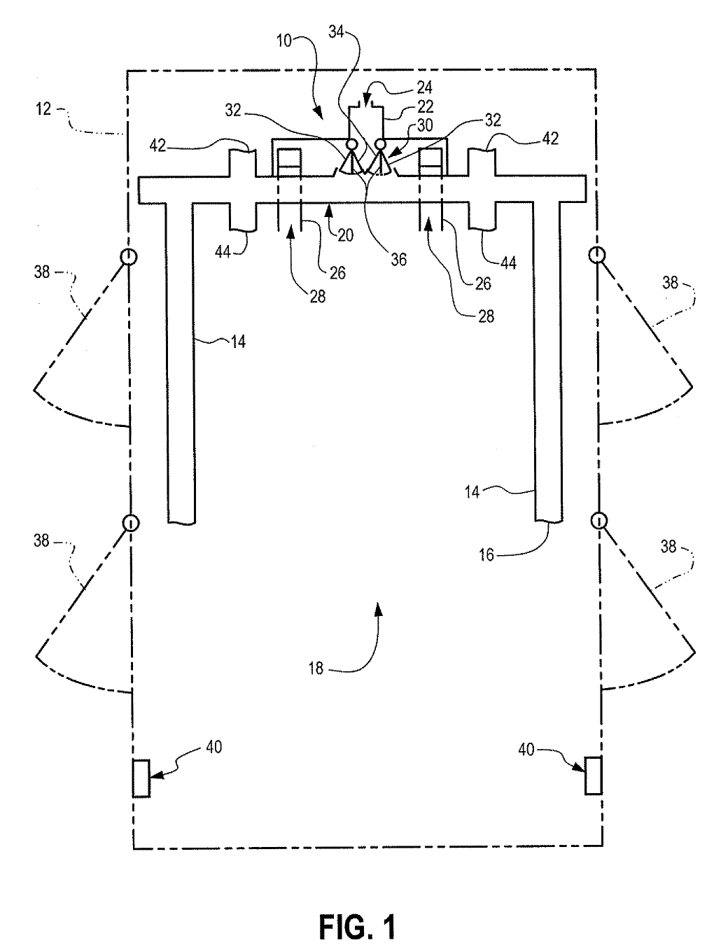

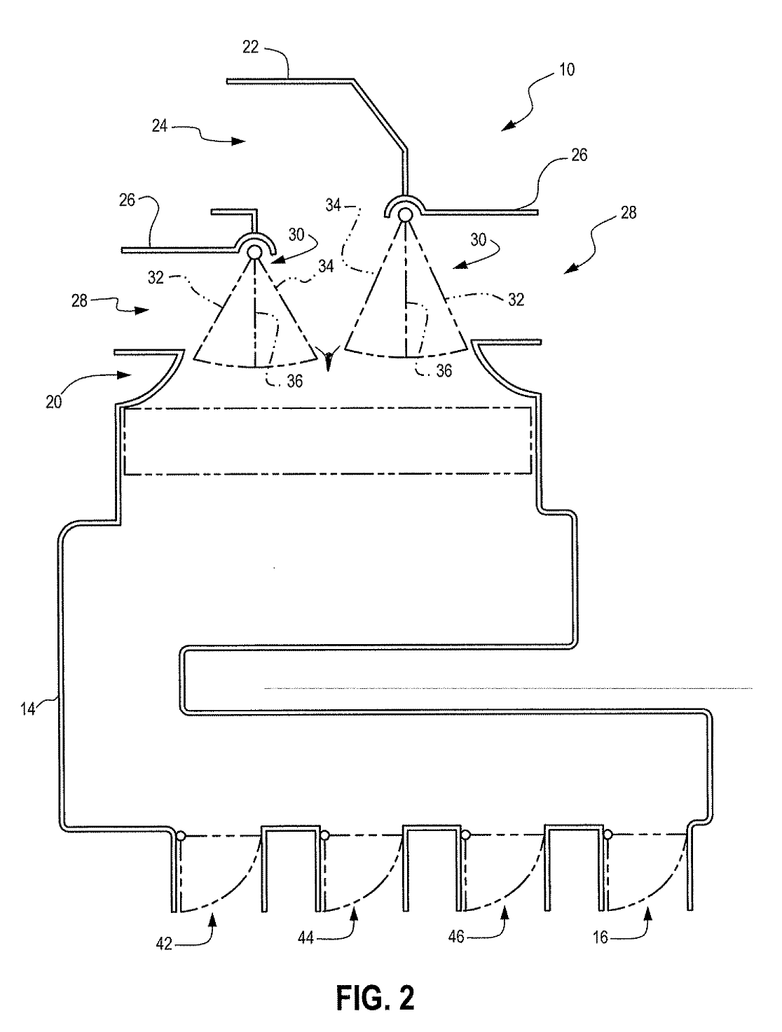

Referring now to FIGS. 1 and 2, in an HVAC control system 10 for a vehicle 12, an interior passage 14 extends between an opening 16 into an interior passenger compartment 18 of the vehicle 12 and an air distribution chamber 20. The fresh air passage 22 extends between an opening 24 external to the passenger compartment 18 of the vehicle 12 and the air distribution chamber 20. A recirculation passage 26 extends between an opening 28 into the interior passenger compartment 18 and the air distribution chamber 20. At least one movable intake door 30 is located in the distribution chamber 20 for changing modes of HVAC operation between a fresh air mode and a recirculation mode. When in the fresh air mode of operation, the at least one movable intake door 30 is in a first position 32 in order to place the fresh air passage 22 in fluid communication with the interior passage 14. When in the recirculation mode of operation, the at least one movable intake or mode door 30 is in a second position 34 in order to place the recirculation passage 26 in fluid communication with the interior passage 14. The configurations illustrated for the passages 14, 22, 26, openings 16, 24, 28, and air distribution chamber 20 are for purposes of illustration only, and can be reconfigured into any appropriate structural shape in order to conform to the space and routing paths for a particular vehicle. For this reason, FIGS. 1 and 2 are shown in a schematic illustration and are not to be interpreted as being limited to the structural layouts as schematically illustrated.

The effect of passenger cabin air pressure on door closing energy is reduced according to an embodiment of the present invention by a software code change in the HVAC control system 10. A partial recirculation mode of HVAC operation can be programmed into the HVAC control system 10. When in the partial recirculation mode of operation, the at least one movable intake door 30 is placed in a third position 36 in order to place the fresh air passage 22, the recirculation passage 26, and the interior passage 14 in fluid communication with one another to reduce closing energy of at least one vehicle door 38 by allowing internal passenger cabin air to be discharged externally from the interior passenger compartment 18 through the fresh air passage 22 during closure of the at least one vehicle door 38.

The partial recirculation mode of operation preferably bypasses heater and/or evaporator cores in order to provide a more direct flow path for exhausting cabin air externally of the internal passenger compartment 18. The partial recirculation mode of operation bypasses the defrost vents 42, front seat occupant vents 44, rear seat occupant vents 46, floor vents 16, ductwork 14, and HVAC heater and evaporator cores (not shown) to open a more direct air outlet path to atmosphere external of the interior passenger compartment 18. The configuration can increase the effective body leakage without a detriment to NVH, since the partial recirculation mode of operation can be activated as required.

Current vehicles 12 rely primarily on the drafter or air pressure exhaust valve 40 typically located at a rear of the vehicle 12 and general body leakage to vent increased pressure in the cabin due to a closing vehicle door 38. The rate at which cabin air travels through the drafter 40 is driven by the size of the drafter 40 and by the restriction in the path from the main cabin volume to the drafter surface. Drafter size is minimized and the restrictions in flow are increased to improve NVH. These factors have increased the air-tight effect in door closing energy.

In order to maximize the effectiveness of reducing the door closing effort according to an embodiment of the present invention, the at least one door 30 of the HVAC control system 10 can be placed in a partial recirculation mode in response to a vehicle condition input signal, by way of example and not limitation, such as when any vehicle door 38 is opened. This type of control can be accomplished on any HVAC systems. The at least one door 30 of the HVAC control system 10 can be positioned in the partial recirculation mode in response to any desired predetermined vehicle condition input signal, by way of example and not limitation, such as any vehicle door opening, vehicle ignition condition change to off state, vehicle transmission placed in park, emergency brake engaged, seat belt change from buckled to unbuckled state, vehicle door lock changed from locked to unlocked condition, and/or seat occupant sensor detection of change from occupied to unoccupied state for any seat. The HVAC control system 10 can revert to either a previous mode of operation position, or to a fresh air mode of operation, depending on the system conditions after a predetermined time. By changing the HVAC mode of operation to partial recirculation, an air path is opened from the HVAC vents or recirculation openings 28 to the cowl inlet or opening 24 at the base of a windshield of the vehicle 12. In current HVAC control systems 10, the recirculation mode closes the inlet path, while the fresh air mode of operation opens an inlet path through the heater and evaporator core that is highly restrictive to air flow. The air flow path that can be created by a partial recirculation mode according to an embodiment of the present invention can allow a sudden increase in cabin air pressure to be released more quickly then in other HVAC modes of operation. It has been found that door closing energy can be reduced by more than 10% of the total target for door closing energy without degrading NVH performance or degrading HVAC system performance, or requiring additional costs or mass in the vehicle 12.

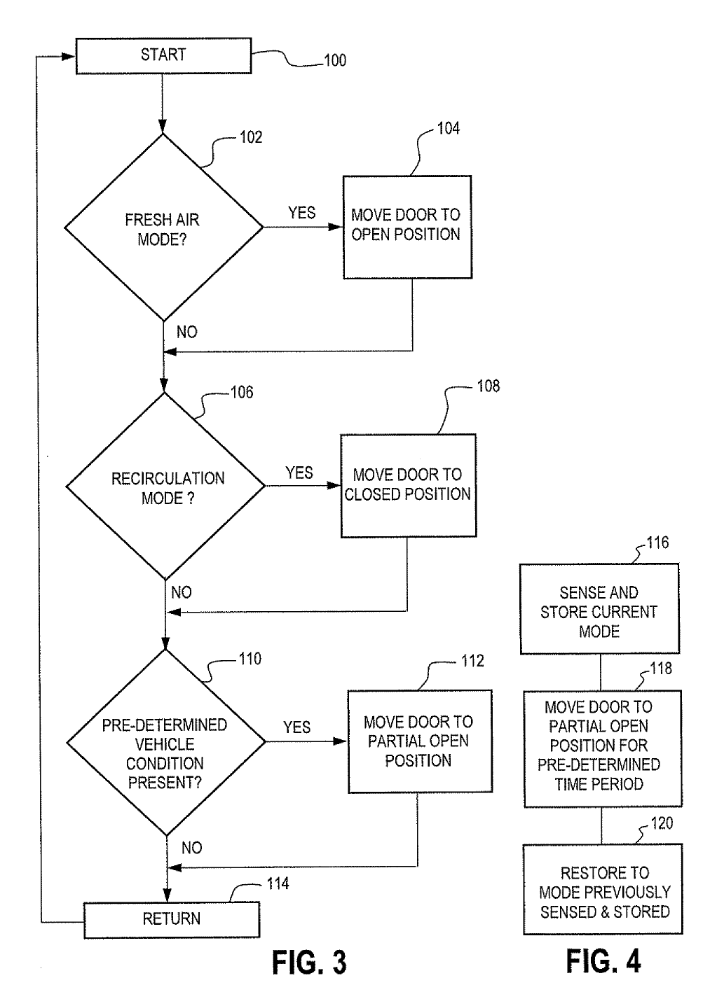

Referring now to FIGS. 3 and 4, the method or process for reducing a vehicle door closing energy can begin at step 100. As previously described with respect to FIGS. 1 and 2, an interior passage 14 can be provided extending between an opening 16 into an interior passenger compartment 18 of the vehicle 12 and an air distribution chamber 20. A fresh air passage 22 can be provided extending between an opening 24 external to the passenger compartment 18 of the vehicle 12 and the air distribution chamber 20. A recirculation passage 26 can be provided extending between an opening 28 and the interior passage compartment 18 and the air distribution chamber 20. At least one movable door 30 can be located in the distribution chamber 20 for movement into different positions to place the HVAC control system 10 into different modes of operation.

By way of example and not limitation, the operation of the HVAC control system 10 will be described with respect to FIGS. 3 and 4. However, it should be recognized that the particular order of the queries described can be changed from that depicted without affecting the operation of the HVAC control system 10. Therefore, the order of queries 102, 106, and 110 are for purposes of illustration only and can be changed as desired.

As depicted in FIG. 3, at some point during the HVAC control system 10 operation query 102 determines whether a fresh air mode of operation is desired. If the answer to query 102 is YES, the control system moves at least one movable door 30 to a first position 32 in order to place the fresh air passage 22 in communication with the interior passage 14 as described in step 104. The control system 10 continues monitoring as depicted after step 104. If the answer to query 102 is NO, the HVAC control system 10 continues operation. During some point of operation of the HVAC control system 10, a determination is made as illustrated in query 106 whether a recirculation mode of operation is desired. If the answer to query 106 is YES, the HVAC control system 10 continues to step 108 where at least one movable door 30 is moved to a second position 34 in order to place the recirculation passage 26 in communication with the interior passage 14. The control system 10 continues monitoring as depicted after step 108. If the answer to query 106 is NO, the HVAC control system 10 continues. At some point, the HVAC control system 10 determines whether at least one predetermined vehicle condition is present or exists as indicated in query 110. The at least one door 30 of the HVAC control system 10 can be positioned in the partial recirculation mode in response to any desired predetermined vehicle condition input signal, by way of example and not limitation, such as any vehicle door opening, vehicle ignition condition change to off state, vehicle transmission placed in park, emergency brake engaged, seat belt change from buckled to unbuckled state, vehicle door lock changed from locked to unlocked condition, and/or seat occupant sensor detection of change from occupied to unoccupied state for any seat. If the answer to query 110 is YES, the HVAC control system 10 continues to step 112 where at least one movable door 30 is moved to a third position 36 in order to place the fresh air passage 22, the recirculation passage 26, and the interior passage 14 in communication with one another to reduce vehicle door closing energy by allowing external discharge of cabin air from the interior passenger compartment 18 through the fresh air passage 14 during vehicle door closure. The control system 10 continues monitoring as depicted after step 112. If the answer to query 110 is NO, the HVAC control system 10 continues. After any movement of the at least one door 30, the HVAC control system 10 continues normal processing until the next query triggers a door 30 movement to a new position. Alternatively, the door 30 can be held in the third position 36 for a predetermined period of time before returning to the previous mode of operation or moving to a preset mode of operation, such as the fresh air mode. As previously described, the queries and corresponding door movements can be performed in any desired order of operation for the HVAC control system 10. As illustrated in FIG. 3, the HVAC control system 10 can continue to a return step 114 forming a closed loop with the start step 100.

Referring now to FIG. 4, the HVAC control system 10 can include additional steps in response to query 110 triggering a partial recirculation mode of operation. Prior to moving at least one movable door 30 to the third position 36, the HVAC control system 10 can sense and store a current mode of operation or position of the door 30. In other words, the system 10 can determine whether the door 30 is in the first position 32, second position 34, or third position 36 prior to movement of the door 30 and can store this information for later retrieval as shown in step 116. The at least one movable door 30 can then be moved to the third position 36 in order to place the fresh air passage 22, recirculation passage 26, and interior passage 14 in communication with one another to reduce vehicle door closing energy as illustrated in step 118. The at least one movable door 30 can be maintained in the third position 36 for a predetermined period of time. After the predetermined period of time has expired, the HVAC control system 10 can restore the at least one movable door 30 to the mode or position previously sensed and stored in step 116, as illustrated in step 120. After restoring the door 30 to the previously sensed door position, the HVAC control system 10 continues normal operation, monitoring whether any change in mode is desired. The method illustrated in FIG. 4 can be implemented by itself as part of a manual HVAC operating system 10, or can be incorporated into an automatic HVAC control system 10 including the method or process illustrated in FIG. 3. In providing operation with respect to a manual HVAC control system 10, the partial recirculation mode of operation can be triggered or activated in response to at least one predetermined condition. By way of example and not limitation, the pre-existing condition can include a vehicle ignition being turned off, a door lock being changed from locked to unlocked, a transmission being placed in park, an emergency brake being applied, a seat occupant sensor state being changed from occupied to unoccupied, and/or a seat belt sensor state being changed from buckled to unbuckled.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. In an HVAC control system for a vehicle including an interior passage extending between an opening into an interior passenger compartment of a vehicle and an air distribution chamber, a fresh air passage extending between an opening external to the passenger compartment of the vehicle and the air distribution chamber, a recirculation passage extending between an opening in the interior passenger compartment and the air distribution chamber, and at least one movable intake door located in the distribution chamber for changing modes of HVAC operation between a fresh air mode, and a recirculation mode, the fresh air mode of operation placing the fresh air passage in fluid communication with the interior passage, the recirculation mode of operation placing the recirculation passage in fluid communication with the interior passage, the improvement comprising:
a partial recirculation mode of HVAC operation, the partial recirculation mode of operation placing the fresh air passage, the recirculation passage, and the interior passage in fluid communication with one another to reduce vehicle door closing energy by allowing external discharge of air from the interior passenger compartment through the fresh air passage during vehicle door closure.

2. The improvement of claim 1, wherein the partial recirculation mode of operation is triggered in response to at least one input signal selected from a group of signals corresponding to vehicle conditions consisting of a vehicle ignition being turned off, a vehicle transmission being shifted into park, an emergency brake being applied, a vehicle seat belt sensor state being changed from buckled to unbuckled, a vehicle door lock being unlocked, a vehicle door being opened, a vehicle seat occupant sensor state being changed from occupied to unoccupied, and any combination thereof.

3. The improvement of claim 1 further comprising:
an input signal for triggering a change of mode of operation to the partial recirculation mode.

4. The improvement of claim 3, wherein a current mode of operation is determined prior to changing to the partial recirculation mode of operation.

5. The improvement of claim 3, wherein the mode of operation changes from the partial recirculation mode of operation after a predetermined time interval to another mode of operation selected from a group consisting of a reversion to a prior mode of operation previously determined and a fresh air mode of operation depending on system conditions.

6. In an HVAC control process for a vehicle including an interior passage extending between an opening into an interior passenger compartment of a vehicle and an air distribution chamber, a fresh air passage extending between an opening external to the passenger compartment of the vehicle and the air distribution chamber, a recirculation passage extending between an opening in the interior passenger compartment and the air distribution chamber, and at least one movable intake door located in the distribution chamber for changing modes of HVAC operation between a fresh air mode, and a recirculation mode, the fresh air mode of operation placing the fresh air passage in fluid communication with the interior passage, the recirculation mode of operation placing the recirculation passage in fluid communication with the interior passage, the improvement of the process comprising:
releasing air from the interior passenger compartment through the fresh air passage during vehicle door closure with a partial recirculation mode of HVAC operation, the partial recirculation mode of operation placing the fresh air passage, the recirculation passage, and the interior passage in fluid communication with one another to reduce vehicle door closing energy.

7. The improvement of claim 6 further comprising:
triggering the partial recirculation mode of operation in response to at least one input signal selected from a group of signals corresponding to vehicle conditions consisting of a vehicle ignition being turned off, a vehicle transmission being shifted into park, an emergency brake being applied, a vehicle seat belt sensor state being changed from buckled to unbuckled, a vehicle door lock being unlocked, a vehicle door being opened, a vehicle seat occupant sensor state being changed from occupied to unoccupied, and any combination thereof.

8. The improvement of claim 6 further comprising:
changing modes of operation between the fresh air mode, the recirculation mode, and the partial recirculation mode in response to an input signal.

9. The improvement of claim 8 farther comprising:
determining a current mode of operation prior to triggering a change of mode to the partial recirculation mode of operation.

10. The improvement of claim 8 further comprising:
changing the mode of operation from the partial recirculation mode of operation after a predetermined time interval to another mode of operation selected from a group consisting of a reversion to a prior mode of operation previously determined and a fresh air mode of operation depending on system conditions.

11. An apparatus for reducing vehicle door closing energy comprising:
an interior passage extending between an opening into an interior passenger compartment of a vehicle and an air distribution chamber;
a fresh air passage extending between an opening external to the passenger compartment of the vehicle and the air distribution chamber;
a recirculation passage extending between an opening in the interior passenger compartment and the air distribution chamber;
at least one movable intake door located in the distribution chamber for changing modes of HVAC operation between a fresh air mode, a recirculation mode, and a partial recirculation mode, the fresh air mode of operation placing the fresh air passage in fluid communication with the interior passage, the recirculation mode of operation placing the recirculation passage in fluid communication with the interior passage, and the partial recirculation mode of operation placing the fresh air passage, the recirculation passage, and the interior passage in fluid communication with one another to reduce vehicle door closing energy by allowing external discharge of air from the interior passenger compartment through the fresh air passage during vehicle door closure; and
a control system for changing modes of operation between the fresh air mode, the recirculation mode, and the partial recirculation mode, wherein the partial recirculation mode of operation is activated in response to predetermined conditions.

12. The apparatus of claim 11, wherein the partial recirculation mode of operation is triggered in response to at least one input signal selected from a group of signals corresponding to vehicle conditions consisting of a vehicle ignition being turned off, a vehicle transmission being shifted into park, an emergency brake being applied, a vehicle seat belt sensor state being changed from buckled to unbuckled, a vehicle door lock being unlocked, a vehicle door being opened, a vehicle seat occupant sensor state being changed from occupied to unoccupied, and any combination thereof.

13. The apparatus of claim 11, wherein the control system is responsive to an input signal for a change of mode of operation to the partial recirculation mode.

14. The apparatus of claim 13, wherein the control system determines a current mode of operation prior to triggering a change of mode to the partial recirculation mode of operation.

15. The apparatus of claim 13, wherein the control system changes the mode of operation from the partial recirculation mode of operation after a predetermined time interval to an other mode of operation selected from the group consisting of a reversion to a prior mode of operation previously determined and a fresh air mode of operation depending on predetermined conditions.

16. A method for reducing vehicle door closing energy comprising:
providing an interior passage extending between an opening into an interior passenger compartment of a vehicle and an air distribution chamber;
providing a fresh air passage extending between an opening external to the passenger compartment of the vehicle and the air distribution chamber;
providing a recirculation passage extending between an opening in the interior passenger compartment and the air distribution chamber;
providing at least one movable intake door located in the distribution chamber for different modes of HVAC operation, the different modes of operation including a fresh air mode, a recirculation mode, and a partial recirculation mode, the fresh air mode of operation placing the fresh air passage in fluid communication with the interior passage, the recirculation mode of operation placing the recirculation passage in fluid communication with the interior passage, and the partial recirculation mode of operation placing the fresh air passage, the recirculation passage, and the interior passage in fluid communication with one another to reduce vehicle door closing energy by allowing external discharge of air from the interior passenger compartment through the fresh air passage during vehicle door closure; and
changing modes of operation between the fresh air mode, the recirculation mode, and the partial recirculation mode with a control system, wherein the partial recirculation mode of operation is activated in response to predetermined conditions.

17. The method of claim 16 further comprising:
triggering the partial recirculation mode of operation in response to at least one input signal selected from a group of signals corresponding to vehicle conditions consisting of a vehicle ignition being turned off, a vehicle transmission being shifted into park, an emergency brake being applied, a vehicle seat belt sensor state being changed from buckled to unbuckled, a vehicle door lock being unlocked, a vehicle door being opened, a vehicle seat occupant sensor state being changed from occupied to unoccupied, and any combination thereof.

18. The method of claim 16 further comprising:
triggering the partial recirculation mode of operation in response to an input signal.

19. The method of claim 18 further comprising:
determining a current mode of operation prior to triggering a change of mode to the partial recirculation mode of operation.

20. The method of claim 18 further comprising:
changing the mode of operation from the partial recirculation mode of operation to an other mode of operation after a predetermined time interval, the other mode of operation selected from a group consisting of a reversion to a prior mode of operation previously determined, and a fresh air mode of operation depending on predetermined system conditions.
